(19) United States
(12) Patent Application Publication
(10) Pub. No.: US 2009/0097495 A1
(43) Pub. Date: Apr. 16, 2009

(54) FLEXIBLE VIRTUAL QUEUES

(75) Inventors: Subbarao Palacharla, Portland, OR (US); Michael Corwin, Sunnyvale, CA (US)

Correspondence Address: HENSLEY KIM & HOLZER, LLC, 1660 LINCOLN STREET, SUITE 3000, DENVER, CO, 80264, US

(73) Assignee: BROCADE COMMUNICATIONS SYSTEMS, INC., San Jose, CA (US)

(21) Appl. No.: 11/870,922

(22) Filed: Oct. 11, 2007

(51) Int. Cl. H04L 12/56

(52) U.S. Cl. 370/413

(57) ABSTRACT

Flexible virtual queues of a switch are allocated to provide non-blocking virtual output queue (VOQ) support. A port ASIC has a set of VOQs, one VOQ per supported port of the switch. For each VOQ, a set of virtual input queues (VIQs) includes a VIQ for each input port of the port ASIC that forms a non-blocking flow with the corresponding output port (and potentially, with the specified level of service) in the switch. The port ASIC selects a VOQ for transmission and then arbitrates among the VIQs of the selected VOQ to select a VIQ from which to transmit the packet. Having identified an appropriate VIQ, the port ASIC transmits cells of the packet at the head of the VIQ to a port ASIC that includes the corresponding output port for reassemble and eventual transmission through the output port.

### BACKGROUND

A storage area network (SAN) may be implemented as a high-speed, special purpose network that interconnects different kinds of data storage devices with associated data servers on behalf of a large network of users. Typically, a storage area network includes high-performance switches as part of the overall network of computing resources for an enterprise. The storage area network is usually clustered in close geographical proximity to other computing resources, such as mainframe computers, but may also extend to remote locations for backup and archival storage using wide area network carrier technologies. Fibre Channel networking is typically used in SANs although other communications technologies may also be employed, including Ethernet and IP-based storage networking standards (e.g., iSCSI, FCIP (Fibre Channel over IP), etc.).

In a typical SAN, one or more switches are used to communicatively connect one or more computer servers with one or more data storage devices. Such switches generally support a switching fabric and provide a number of communication ports for connecting to other switches, servers, storage devices, or other SAN devices.

For certain ports on a switch, a non-blocking port configuration may be beneficial. In a non-blocking configuration, an input port's communication through one output port of a switch will not affect the availability of another output port of the switch to that input port. For example, assume a message X is received from a first switch at a port A of a second switch and is destined for port B of the second switch for communication to a data storage device. Also assume that another message Y is received from the first switch at port A of the second switch and is destined for port C of the second switch for communication to another data storage device. To be non-blocking, if communication of message X via port B is slow (e.g., because of a low bandwidth connection to the data storage device), the communication of message Y via port C should not be slowed because of the congestion at port B. A port connected to an inter switch link (ISL) is an example of a port often configured to be non-blocking.

To accomplish non-blocking operation in a switch, many switches incorporate a large number of virtual output queues (VOQs) for each non-blocking flow supported by the switching fabric. Such virtual output queues eliminate head-of-line blocking by queuing packets in per-flow queues (i.e., separate queues for each combination of non-blocking input port, output port, and service level). As such, for each input port/output port/service level combination forming a non-blocking flow, the number of virtual queues is typically N*S, where N represents the number of output ports supported by the switching fabric and S represents the number of levels of service supported by the switch.

However, in existing approaches, the amount of memory required for a switch having a nontrivial number of non-blocking flows quickly becomes expensive and is not economically scalable or sufficiently flexible. For example, for a switch configuration of 1536 total switch ports with each port supporting 8 service levels and port application-specific integrated circuits (ASICs) (also referred to as a “port circuit”) supporting 24 ports each, the number of virtual output queues for each port ASIC is (N×S×P)=294,912 (1536×8×24). To exhaustively implement this many queues in each port ASIC is likely to be prohibitive in terms of cost and silicon area and may require an undesirable off-chip memory.

### SUMMARY

Implementations described and claimed herein address the foregoing problems by providing a method of flexibly managing virtual queues of a switching system in which the virtual queues are allocated from a central pool by software to provide non-blocking support for a specified combination of input ports, output ports, and service levels. In many real-world configurations, only a small subset of output ports on a switch are typically configured for full non-blocking access, although which combinations of input ports/output ports/service levels are actually non-blocking during operation may not be known until the user sets up the switch. Therefore, the virtual queues may be dynamically configured according to actually user needs at switch installation time. As such, a small virtual queue shared memory per port ASIC is sufficient if managed by a flexible virtual queuing method.

In one implementation, a port ASIC has a set of virtual output queues, one virtual output port per supported port in the switch, and for each virtual output queue, a set of virtual input queues (VIQs) including a virtual input queue for each input port that forms a non-blocking flow for a given output port and level of service supported by the port ASIC. The port ASIC selects among the virtual output queues to select a virtual output queue and then arbitrates among the virtual input queues of the selected virtual output queue to select a virtual input queue from which to transmit the packet toward the intended output port. The virtual output queues and associated virtual input queues are recorded in shared memory to allow flexible virtual queue management. Having identified the virtual input queue of the selected virtual output queue from which to transmit the frame, the port ASIC transmits cells of the packet to a port ASIC of the output port for reassembly and eventual transmission through the output port.

Other implementations are also described and recited herein.

### BRIEF DESCRIPTIONS OF THE DRAWINGS

FIG. 1 illustrates an exemplary computing and storage framework including a local area network (LAN) and a storage area network (SAN).

FIG. 2 illustrates an exemplary switch configured with flexible virtual queues.

FIG. 3 illustrates an exemplary arrangement of flexible virtual queues.

FIG. 4 illustrates flexible virtual queuing structures and functional components of an exemplary flexible queuing configuration.

FIG. 5 illustrates exemplary operations for receiving a packet from an input port of a port ASIC using a flexible virtual queuing configuration.

FIG. 6 illustrates exemplary operations for transmitting a packet toward an output port of a switch using a flexible virtual queuing configuration.

### DETAILED DESCRIPTIONS

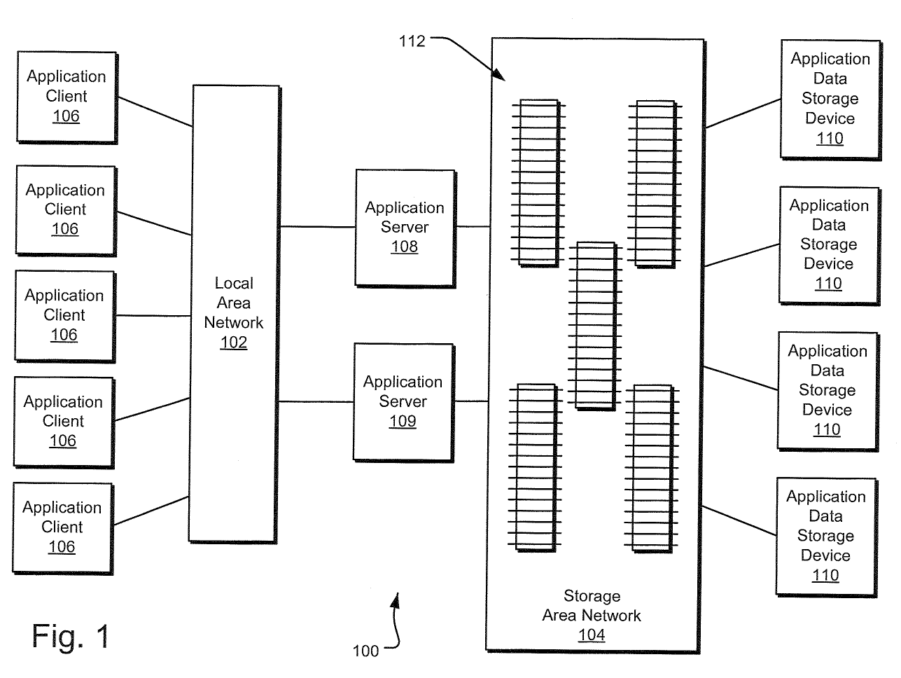

FIG. 1 illustrates an exemplary computing and storage framework 100 including a local area network (LAN) 102 and a storage area network (SAN) 104. Various application clients 106 are networked to application servers 108 and 109 via the LAN 102. Users can access applications resident on the application servers 108 and 109 through the application clients 106. The applications may depend on data (e.g., an email database) stored at one or more of the application data storage devices 110. Accordingly, in the illustrated example, the SAN 104 provides connectivity between the application servers 108 and 109 and the application data storage devices 110 to allow the applications to access the data they need to operate. It should be understood that a wide area network (WAN) may also be included on either side of the application servers 108 and 109 (i.e., either combined with the LAN 102 or combined with the SAN 104).

With the SAN 104, one or more switches 112 provide connectivity, routing and other SAN functionality. Some such switches 112 may be configured as a set of blade components inserted into a chassis or as rackable or stackable modules. The chassis has a back plane or mid-plane into which the various blade components, such as switching blades and control processor blades, may be inserted. Rackable or stackable modules may be interconnected using discrete connections, such as individual or bundled cabling.

In the illustration of FIG. 1, at least one switch 112 includes a flexible virtual queuing mechanism that provides non-blocking access between one or more input-output port pairs. In one implementation, one or more port ASICs within a switch 112 uses shared memory to store virtual queues including one or more virtual output queues, with each virtual output queue having a set of virtual input queues. The shared memory can be configured to support the number of non-blocking port-to-port paths (or flows) specified for the switch 112. In one implementation, a memory controller allocates the one or more virtual output queues and the one or more virtual input queue for each virtual output queue.

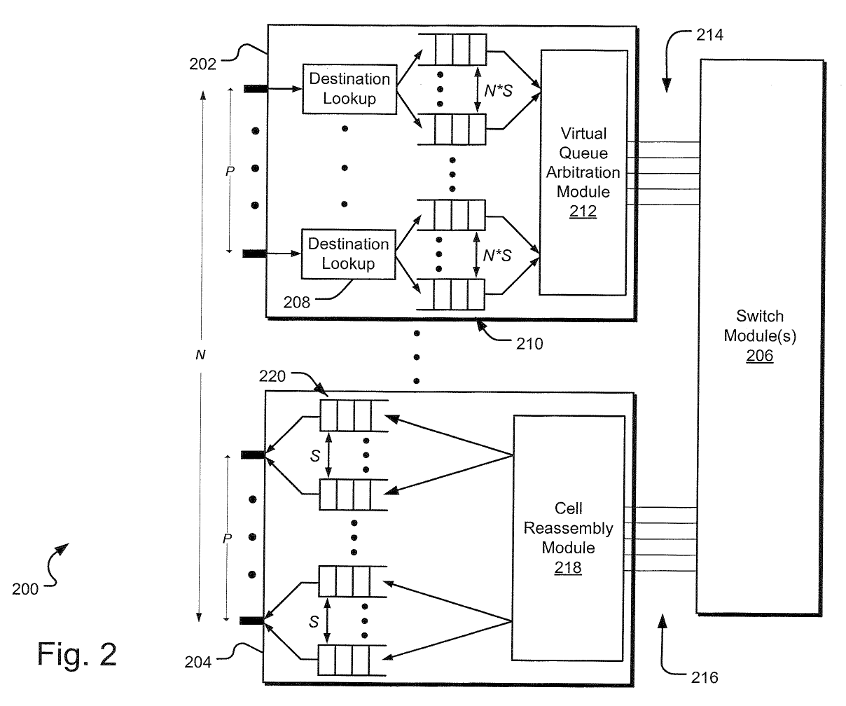

FIG. 2 illustrates an exemplary switch 200 configured with flexible virtual queues. The switch 200 supports N total ports using a number of port ASICs (see e.g., port ASICs 202 and 204) coupled to one or more switch modules 206 that provide the internal switching fabric of the switch 200. Each port ASIC includes P ports, each of which may represent an input port or an output port depending on the specific communication taking place at a given point in time.

An ingress path for an example communication is shown with regard to a port ASIC 202, although it should be understood that any port ASIC in the switch 200 may act to provide an ingress path. The ingress path flows from the input ports on the port ASIC 202 toward the switch modules 206, which receives cells of packets from the port ASIC 202. An egress path for the example communication is shown with regard to port ASIC 204, although it should be understood that any port ASIC in the switch 200 may act to provide an egress path, including the same port ASIC that provides the ingress path. In FIG. 2, the egress path flows from the back ports receiving cells from the switch modules 206 toward the output ports on the port ASIC 204.

Upon receipt of a packet by the port ASIC 202, a destination lookup module (such as destination lookup module 208) examines the packet header information to determine the output port in the switch 200 and the level of service specified for the received packet. In one implementation, the port ASIC 200 maintains a content-addressable-memory (CAM) that stores a forwarding database. The destination lookup module 208 searches the CAM to determine the destination address of the packet and searches the forwarding database to determine the output port of the switch 200 through which the packet should be forwarded. The destination lookup module 208 may also determine the level of service specified in the packet header of the received packet, if multiple levels of service are supported, although an alternative module may make this determination. Furthermore, in one implementation, the destination lookup module 208 may also evaluate the input port to determine whether the particular input port to output port flow is configured as a non-blocking flow in order to provide an appropriate virtual input queue mapping for the input port.

Having identified the output port, the destination lookup module 208 passes the packet to a flexible virtual queuing mechanism 210, which inserts the packet into a flexible virtual queue corresponding to the identified level of service (if multiple levels of service are supported), the identified output port, and the input port through which the packet was initially received by the switch 200. The received packet itself is stored into a packet buffer, and an appropriate virtual input queue is configured to reference the packet buffer.

In one implementation for configuring the virtual input queue to reference the newly received packet in the packet buffer memory, a virtual output queue selector of the flexible virtual queuing mechanism 210 identifies a virtual output port via virtual queue mapping pointer in an N*S virtual queue mapping memory array, based on the output port and the specified level of service. Further, a virtual input queue selector identifies the appropriate virtual input queue of the selected virtual output queue. In one implementation, the virtual input queue selector combines the virtual queue mapping pointer with an input port index identifying the receiving input port in order to reference head and/or tail pointers to the packet buffer. Each head pointer points to a packet buffer in the packet memory that is located at the beginning of a virtual input queue. Each tail pointer points to a packet buffer in the packet memory that is located at the end of a virtual input queue. The head and tail lists are structured to define a set of N*S*k queues, wherein k represents the number of non-blocking input ports. When receiving a packet through an input port, a packet access module copies the received packet into an available packet buffer and updates the selected virtual input queue (e.g., a tail pointer of the queue) to reference the newly filled packet buffer.

When transmitting a received packet onward to an intended output port within the switch, a virtual output queue selector of a virtual queue arbitration module 212 selects a virtual output queue and a virtual input queue selector of the virtual queue arbitration module 212 arbitrates among the virtual input queues to select the virtual input queue of the selected virtual output queue from which to transmit the next packet across the backplane links 214 and the switch module(s) 206 to the port ASIC containing the output port. In one implementation, the virtual arbitration module 212 selects virtual output queues on a round robin basis, and then arbitrates among the virtual input queues of the selected virtual output queue using a weighted arbitration scheme in order to select the next packet to be transmitted to its intended output port.

In the illustration of FIG. 2, the port ASIC 204 includes the intended output port for the example received packet. Accordingly, a packet access module of the virtual queue arbitration module 212 extracts individual cells of the packet at the head of the selected virtual input queue and forwards each cell over the backplane links 214, through the switch modules(s) 206, over the backplane links 216 to the port ASIC 204. Each packet cell includes a destination port ASIC identifier and an output port identifier to accommodate routing of the cell through the switch module(s) 206 to the appropriate port ASIC. Furthermore, each cell includes a sequence number to allow ordered reassembly of the received cells into the original packet.

The egress path of the port ASIC 204 includes S egress queues 220 for each output port. A cell reassembly module 218 reassembles the received packet from its constituent cells and passes the reassembled packet to an egress queue associated with the identified output port and the specified level of service. The cell reassembly module 218 can extract output port and level of service information to determine the appropriate egress queue into which the reassembled packet should be placed. The port ASIC 204 then transmits the reassembled packet from the appropriate egress queue when the packet reaches the head of the egress queue.

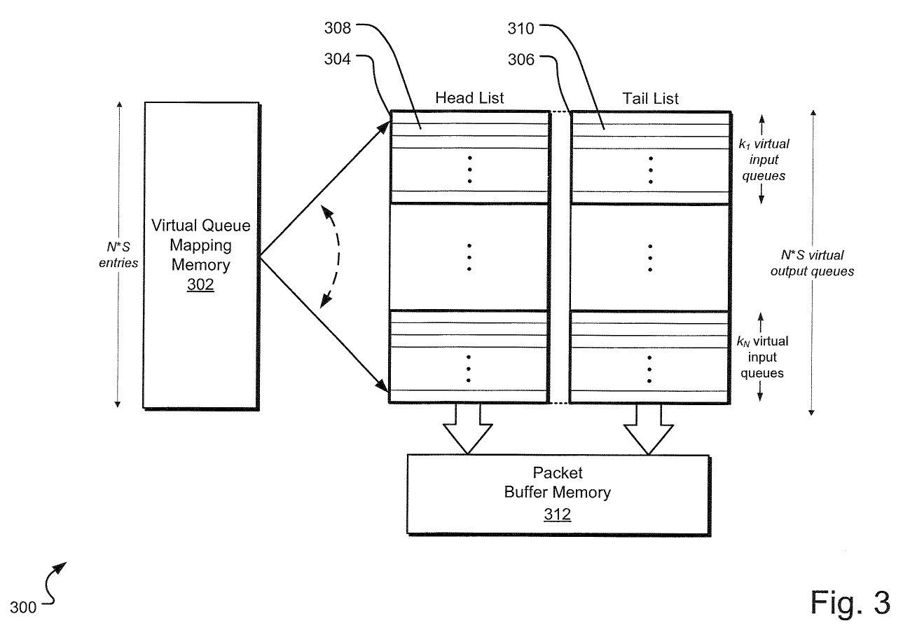

FIG. 3 illustrates an exemplary arrangement of flexible virtual queues 300. In one implementation, a virtual queue mapping memory 302 forms an array of N*S entries, wherein each entry includes a virtual output queue pointer, a length field, and a winner field. The indexing of the virtual queue mapping memory 302 allows a reference to individual virtual output queue entries based on the output port and level of service of a given packet.

In the ingress flow, the port ASIC determines the destination address and level of service specified by the packet and searches a forwarding database to determine the output port of the switch through which the packet should be forwarded. The port ASIC also determines an input port mapping from the packet and other configuration information pertaining to whether a non-blocking flow is implicated. In one implementation, the input port mapping is defined as follows (where x represents the number of input ports forming a non-blocking flow with a given output port and level of service), although alternative mappings are contemplated:
If x=0 for a given output port and level of service, then all input ports are “blockable” and are mapped to a shared virtual input queue for the virtual output queue associated with the output port and level of service (i.e., k=1).
If 0<x<P for a given output port and level of service, then the input ports forming a non-blocking flow with the given output port and level of service are mapped one-to-one to distinct virtual input queues for the virtual output queue associated with the output port and level of service, and all other (“blockable”) input ports are mapped to an additional shared virtual input queue for the virtual output queue associated with the output port and level of service (i.e., kε[1, P] and k=x+1).
If x=P for a given output port and level of service, then input ports are mapped one-to-one to distinct virtual input queues for the virtual output queue associated with the output port and level of service (i.e., k=P).

Accordingly, each input port on the port ASIC 202 is mapped to a virtual input queue index that references into the virtual input queues of the virtual output queue maintained by the port ASIC 202. Input port/output port/service level combinations configured for non-blocking flow are uniquely assigned to distinct virtual input queues associated with the appropriate virtual output queue, and input port/output port/service level combinations configured for “blockable” flow may be assigned to a shared virtual input queue associated with the appropriate virtual output queue. The number of virtual input queues for each virtual output queue j is designated by kⱼ, where kⱼ is in [1, P] and j is in [1, N].

It should be understood however that a more typical configuration includes far fewer than P input ports forming non-blocking flows with a set of output ports at a set of service levels. In other words, a typically configuration may include far fewer than P input ports forming non-blocking flows with far fewer than N output ports at far fewer than S service levels. As such, the amount of memory required to service all of the non-blocking flows at any specific configuration is greatly reduced from the worst case, exhaustive configuration. Further, the flexible queue configuration allows non-blocking flows to be configured among any specific combination of input ports, outputs ports, and levels of service at installation or set-up time.

The received packet is copied into a packet buffer memory 312, and the flexible virtual queues are updated to reference the packet. Based on the output port and level of service, the port ASIC selects a virtual output queue pointer from the appropriate entry in the virtual queue mapping memory 302. For example, if output port 65 and service level 5 are specified, then the virtual output queue pointer at index (65*S)+5 within the virtual queue mapping memory 302 is selected, where S is the number of levels of service supported by the port ASIC. The selected virtual output queue pointer references a virtual output queue (e.g., as represented by the bold boxes 304 and 306) in the head list and tail list. To complete identification of the virtual input queue of the referenced virtual output queue in which to insert the received packet, the port ASIC in the described implementation concatenates a virtual input queue index to the end of the virtual output queue pointer, thereby identifying the specific virtual input queue (e.g., as represented by boxes 308 and 310) of the appropriate virtual output queue in which to insert the received packet. The identified virtual input queue of the appropriate virtual output queue is then updated to reference the newly received packet within the packet buffer memory 312. For example, the linked list constituting the virtual input queue structure and the tail pointer of the appropriate virtual input queue are updated to reference the new packet buffer.

At an appropriate time, the port ASIC selects a virtual output queue (e.g., on a round robin basis) and then arbitrates among the virtual input queues of the selected virtual output queue (e.g., on a weighted arbitration basis) to select the virtual input queue from which the next packet is to be transmitted from the port ASIC. The virtual output queue pointer and the virtual input queue index of the virtual input queue that wins the arbitration are then combined to reference into the appropriate virtual input queue of the selected virtual output queue. The cells of the packet at the head of the selected virtual input queue are transferred across the backplane links to a destination port ASIC for transmission through the intended output port. When the packet buffer is no longer required, the port ASIC updates the virtual input queue by changing the head pointer in the head list to point at the next packet buffer in the virtual input queue and freeing the packet buffer for use with a subsequently received packet.

It should be understood that other configurations of virtual queues may be implemented in a similar fashion. For example, although FIG. 3 is described as having a set of virtual input queues (associated with input ports) for each virtual output queue (associated with an output port). However, the arrangement can be inverted so that each virtual input queue (associated with an input port) includes a set of virtual output queues (associated with output ports). Furthermore, at least one virtual input queue may be associated directly with a source address of the received packet. Likewise, in the inverted configuration, at least one virtual output queue may be associated directly with a destination address of the received packet.

The following examples are given as demonstrations of the efficient memory use in a port ASIC provided by the described implementations, given P=24 input ports (0-23) on the ASIC, N=1536 output ports (0-1535) on the switch in which the ASIC resides, and S=8 levels of service (0-7) supported across all output ports on the ASIC (Note: the examples assume any shared virtual input queues are at the end of each virtual output queue):
If all input ports 1 to P are blockable at all service levels (i.e., no input-to-output port flows are non-blockable at any service level), then k=1 and the port ASIC maintains 1536*8 (i.e., N*S*1) virtual queues, with each virtual output queue including a single shared virtual input queue. As such, a frame received at input port 1 of the port ASIC, destined for output port 1500 of the switch at a service level 2 would be copied to virtual input queue with an index of 1500*8+2 (i.e., to the shared virtual input queue of the third virtual output queue of the 1500^{th} output port).
If input ports 0<x<P are non-blocking to all output ports on the switch at all service levels and all other input port/output port/service level combinations are blockable, then k=x+1 and the port ASIC maintains 1536*8*k (i.e., N*S*k) virtual queues, with each virtual output queue including x virtual input queues and a single shared virtual input queue. For example, if 2 input ports form non-blocking flows with all output ports, then the port ASIC maintains 1536*8*3 virtual queues. As such, a frame received at non-blocking input port 2 in the ASIC, destined for output port 1500 at a service level 2 would be copied to virtual output port with an index of 1500*8*2+2 (i.e., to the third virtual input queue of the third virtual output queue of the 1500^{th} output port). In contrast, a frame received at blockable input port 4 in the port ASIC, destined for output port 1500 of the switch at a service level 2 would be copied to virtual input queue with an index of 1500*8*3+2 (i.e., to the shared virtual input queue of the third virtual output queue of the 1500^{th} output port).
In the extreme case, in which all input ports P are non-blocking to all output ports N at all service levels, then k=P and the port ASIC maintains 1536*8*24 (i.e., N*S*P) virtual queues, with each virtual output queue including a single shared virtual input queue. As such, a frame received at input port 1 of the port ASIC, destined for output port 1500 of the switch at a service level 2 would be copied to virtual input queue with an index of 1500*8*P+2 (i.e., to the virtual input queue of the third virtual output queue of the 1500^{th} output port).

As discussed previously, however, it should be understood that many intermediate combinations exist between the fully blockable case and the fully non-blocking case. That is, a wide assortment of input port/output port/service level combinations is available to provide non-blocking flows. Given this flexibility, the more typical configuration in which a small number of input port/output port/service level combinations are set for non-blocking operation may be configured by the user without requiring significant memory resources for any other combinations.

Accordingly, the fully non-blocking case may be deleted as an option in order to conserve memory needs of a port ASIC. Instead, the memory requirements may be computed according to a number of allowable non-blocking flows. For example, a port ASIC may be configured to allow only 2 input ports to maintain non-blocking flows with only 3 output ports at 4 levels of service (i.e., 3 output ports*4 levels of service*(2 input ports+1 shared queue)=3*4*3), substantially reducing the number of virtual queues from the extreme case (e.g., 1536*8*24). This example shows how a small memory in each port ASIC can support a large number of possible non-blocking input port/output port/service level combinations, such that the specific combination can therefore be configured at installation or set up time.

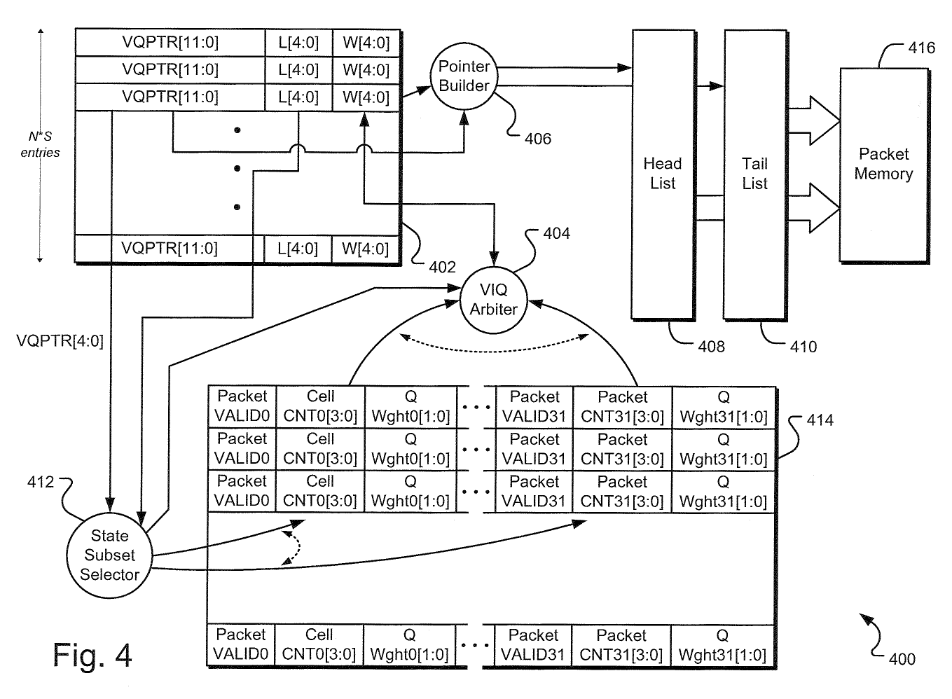

FIG. 4 illustrates flexible virtual queuing structures and functional components of an exemplary flexible queuing configuration 400. In the illustrated implementation, a virtual queue mapping memory 402 includes a virtual output queue pointer field (e.g., VQPTR[11:0]), which points to individual groupings of one or more virtual input queues associated with a given virtual output queue. In one implementation, the virtual output queue pointer fields are indexed within the virtual queue mapping memory 402 in groups of service levels for each output port, although other groupings and indexing may be employed.

Each virtual output queue is associated with a given output port and level of service and includes one or more virtual input queues, according to the mappings configured for each output port/service level combination. For example, if a port ASIC has 32 ports, each output port/service level combination for the switch corresponds to a distinct virtual output queue, wherein each virtual output queue includes 1-32 virtual input queues, depending on the number of non-blocking flows supported by the output port/service level combination.

In one mapping configuration, for example, if zero input ports of a port ASIC form a non-blocking flow with a given output port/service level combination, then the virtual output queue for that output port/service level combination includes a single virtual input queue shared by all of the input ports of the port ASIC. Alternatively, if k is in [1, P−1], where k input ports of the port ASIC form non-blocking flows with a given output port/service level combination, then the virtual output queue for that output port/service level combination includes k distinct virtual input queues, one for each non-blocking flow, plus a single virtual input queue shared by the remaining (blockable) input ports of the port ASIC. If k=P for a given output port/service level combination, then the virtual output queue for that output port/service level combination includes P distinct virtual input queues, one for each non-blocking flow.

In one implementation, each virtual output queue pointer in the virtual queue mapping memory 402 is also associated with a length field (e.g., L[4:0]) representing the number of virtual input queues included in the corresponding virtual output queue. Furthermore, each virtual output queue pointer in the virtual queue mapping memory 402 is also associated with a winner field (e.g., W[4:0]) representing the index of the virtual input queue (of the identified virtual output queue) selected as the winner of a virtual input queue arbitration (e.g., a weighted arbitration scheme) performed by a VIQ arbiter 404. The combination (e.g., concatenation) of the virtual output queue pointer and the virtual input queue index stored in the winner field may be used to construct (e.g., by a pointer builder 406) a virtual input queue pointer to the appropriate head and/or tail pointers of the virtual queue pointer arrays 408 and 410.

When loading a packet into a virtual input queue, the virtual output queue pointer associated with the output port and the service level is combined with an index of the input port through which the packet was received to build a pointer into the tail list 410. The packet is stored in a packet buffer of a packet memory 416 and is inserted in the appropriate virtual input queue referenced by the pointer. In one implementation, the virtual input queue includes a linked list of pointers to packet buffers, although other data structures may be employed. Therefore, in such an implementation, the linked list pointer and the tail list pointer for the virtual input queue are updated to point to the newly filled packet buffer, thereby placing the packet at the end of the appropriate virtual input queue.

When selecting a packet from a virtual input queue for transmission toward the output port, the port ASIC selects a virtual output queue in the virtual mapping memory and arbitrates to determine the virtual input queue for the selected virtual output queue from which to transmit the next packet. For each arbitration, a state subset selector 412 selects an appropriate subset of virtual queue arbitration parameters from a virtual arbitration state memory 414, based on the current virtual output queue pointer and the value of the corresponding length field; and communicates the selected subset to the VIQ arbiter 404. The VIQ arbiter 404 receives a value from the winner field representing the winner of the previous arbitration for a given virtual output queue and then evaluates virtual input queue arbitration parameters characterizing each of the virtual input queues to select a new winner for the current virtual output queue. The VIQ arbiter 404 loads the index of the winning virtual input queue into the winner field of the current virtual mapping entry, which is used to construct the pointer to the appropriate virtual input queue in the head array 408 or tail array 410. The packet at the head of the winning virtual input queue is transmitted from the corresponding packet buffer, which is then removed from the virtual input queue by updating the head list pointer to point to the next packet in the queue. The packet buffer is then made available for use with another received packet in the future.

In the illustrated example, the virtual arbitration state memory 414 includes a row for each virtual output queue and each row includes a trio of fields for each virtual input queue, where each row (corresponding to a virtual output queue) in the virtual arbitration state memory 414 includes 1 to P field trios. Note: Even though each illustrated row is shown as including 32 field trios, any row may include fewer than 32 field trios. Each field trio in the illustrated implementation includes:
Packet VALIDx—a flag indicating whether a valid packet resides at the head of the corresponding virtual input queue x.
Cell CNTx—the number of cells sent from the corresponding virtual input queue x; increments with each cell transmission; gets reset after Cell CNTx reaches Q Wghtx.
Q Wghtx—a weight representing the number of cells to be sent from the corresponding virtual input queue x before moving to the next virtual input queue in the weighted round robin scheme.

In the illustrated example, the virtual input queue associated with the current virtual output queue having the highest weight wins the arbitration. However, it should be understood that other arbitration parameter sets and methods of arbitrating among the virtual input queues of the current virtual output queue may be employed, including deficit weighted round robin, fixed priority, etc.

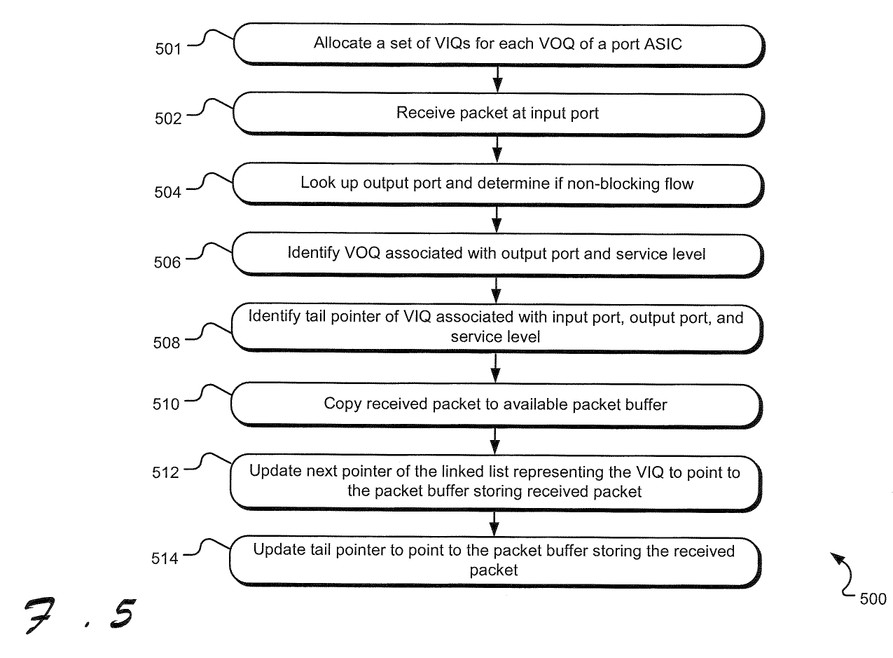

FIG. 5 illustrates exemplary operations 500 for receiving a packet from an input port of a port ASIC using a flexible virtual queuing configuration. An allocating operation 501 allocates a set of virtual input queues for each of a set of virtual output queues. Virtual output queues may be allocated for each output port and each level of service supported by a switch. Note: In one implementation, the virtual input queues and virtual output queues are allocated at initialization time and need not be reallocated with each newly received packet, although it should be understood that the allocation of virtual input queues and virtual output queues may be updated dynamically according to system configuration changes.

A receiving operation 502 receives a packet at an input port of a port ASIC of a switch. A lookup operation 504 examines the packet and determines its intended level of service. The lookup operation 504 also determines the destination address of the packet and uses the destination address to determine the output port of the switch through which the packet is to be transmitted. In one implementation, determination of the output port is accomplished through a routing table in a content addressable memory (CAM), although other methods may be employed. Based on knowledge of the input port of the port ASIC, the identified output port, and the identified level of service, the lookup operation 504 determines (e.g., looks up in a CAM) whether the flow associated with these characteristics is designated as non-blocking.

An identifying operation 506 identifies a virtual output queue associated with the output port and level of service. For example, such identification is accomplished by computing an index associated with the output port and level of service and indexing into a virtual queue mapping memory based on that index. In one implementation, a result of the identifying operation 506 is a virtual output queue pointer (e.g., VQPTR) associated with the identified virtual output queue.

Another identifying operation 508 constructs a virtual input queue pointer based on the virtual output queue pointer and an index associated with the input port through which the packet was received. The virtual input queue pointer points to a virtual input queue tail pointer in a tail list, where the virtual input queue tail pointer points to the last packet buffer in the relevant virtual input queue. A copying operation 510 copies the received packet into an available packet buffer. An updating operation 512 updates the next pointer of a linked list embodying the selected virtual input queue to insert the newly filled packet buffer at the end of the selected virtual input queue. Another updating operation 514 updates the tail pointer to point to the same packet buffer. By the described exemplary operations of FIG. 5, an appropriate virtual input queue of an appropriate virtual output queue is populated to reference a packet buffer of a newly received packet.

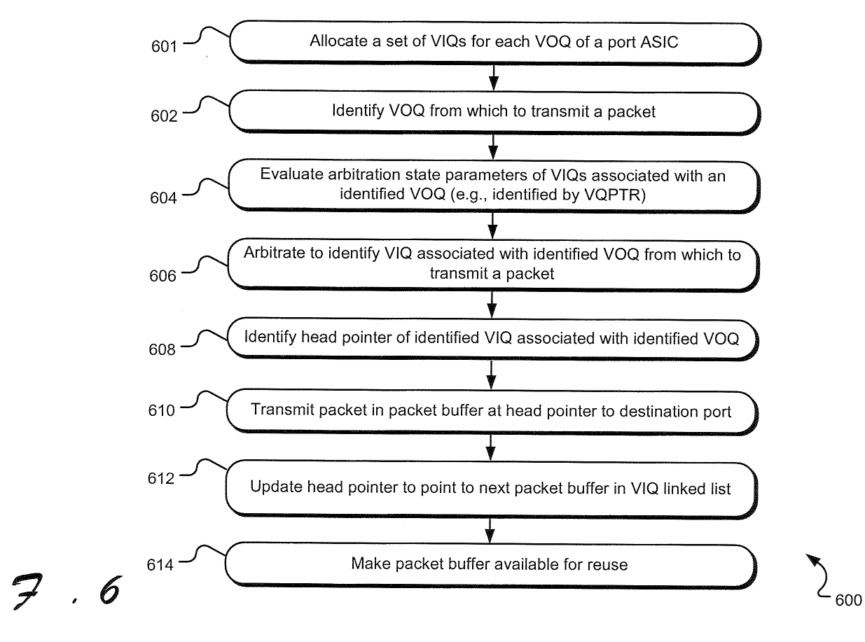

FIG. 6 illustrates exemplary operations 600 for transmitting a packet toward an output port of a switch using a flexible virtual queuing configuration. An allocating operation 601 allocates a set of virtual input queues for each of a set of virtual output queues. Virtual output queues may be allocated for each output port and each level of service supported by a switch. Note: In one implementation, the virtual input queues and virtual output queues are allocated at initialization time and need not be reallocated with each newly received packet, although it should be understood that the allocation of virtual input queues and virtual output queues may be updated dynamically according to system configuration changes.

An identifying operation 602 identifies a virtual output queue from which to transmit the packet (e.g., a round robin selection scheme). An evaluation operation 604 evaluates arbitration state parameters associated with the virtual input queues of the identified virtual output queue. In one implementation, the arbitration state parameters identify the virtual input queues containing valid packets, the number of packets in each virtual input queue, and a weight associated with the virtual input queue, which is used in arbitrating among the virtual input queues of the virtual output queue.

An arbitration operation 606 arbitrates among the virtual input queues of the identified virtual output queue using the arbitration state parameters to choose a winning virtual input queue from which a packet at the head of the virtual input queue should be transmitted toward the output port of the switch. An identifying operation 608 combines the index of the winning virtual input queue with the current virtual output queue pointer to construct a head pointer (e.g., in a head list) to the winning virtual input queue. A transmission operation 610 transmits the packet in the packet buffer referenced by the head pointer toward the output port of the switch associated with the virtual output queue. In one implementation, multiple cells of the packets are distributed or “sprayed” through backplane links and a switching fabric and then reassembled at a port ASIC that includes the output port. An updating operation 612 updates the head pointer of the virtual input queue head list to point to the next packet buffer in the virtual input queue linked list, and a freeing operation 614 makes the transmitted packet's packet buffer available for reuse by a subsequently received packet. By the described exemplary operations of FIG. 6, a packet is selected from an appropriate virtual input queue of an appropriate virtual output queue and transmitted toward its appropriate output port in the switch.

Similar methods may be applied to inverted configurations, or to configurations that include source address associated virtual input queues or destination address associated virtual output queues.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A method of managing virtual queues in a port circuit of a switching device, wherein the switching device includes multiple output ports and the port circuit includes multiple input ports, the method comprising:
allocating a virtual output queue for each output port of the switching device and a set of one or more virtual input queues for each virtual output queue, the set of virtual input queues including a virtual input queue associated with an input port of the port circuit;
selecting a virtual output queue associated with an output port to which a packet received by the port circuit is destined;
identifying a virtual input queue of the selected virtual output queue, the virtual input queue being associated with the input port through which the packet was received by the port circuit; and
accessing the packet in a packet buffer referenced by a pointer in the identified virtual input queue.

2. The method of claim 1 wherein the allocating operation comprises:
for a virtual output queue of the allocated virtual output queues, allocating a distinct virtual input queue for each input port forming a non-blocking flow with an output port corresponding to the virtual output queue.

3. The method of claim 1 wherein the allocating operation comprises:
for a virtual output queue of the allocated virtual output queues, allocating a distinct virtual input queue for each input port forming a non-blocking flow with a combination of an output port corresponding to the virtual output queue and a level of service supported by the input port and the output port.

4. The method of claim 1 wherein the allocating operation comprises:
for a virtual output queue of the allocated virtual output queues, allocating a virtual input queue shared by each input port that does not form a non-blocking flow with an output port corresponding to the virtual output queue.

5. The method of claim 1 wherein the allocating operation comprises:
for a virtual output queue of the allocated virtual output queues, allocating a virtual input queue shared by each input port that does not form a non-blocking flow with a combination of an output port corresponding to the virtual output queue and a level of service supported by the input port and the output port.

6. The method of claim 1 wherein the identifying operation comprises:
determining a pointer to the virtual input queue of the selected virtual output queue to identify the virtual input queue into which the packet should be inserted, wherein the virtual input queue is associated with the input port through which the packet was received by the port circuit.

7. The method of claim 1 wherein the identifying operation comprises:
arbitrating among the virtual input queues of the selected virtual output queue to select a virtual input queue from which to transmit the packet from the switching device.

8. The method of claim 1 wherein the accessing operation comprises:
copying the packet into the packet buffer referenced by the pointer in the identified virtual input queue.

9. The method of claim 1 wherein the accessing operation comprises:
extracting the packet from the packet buffer at the head of the selected virtual input queue;
transmitting the extracted packet toward the output port of the switching device.

10. The method of claim 1 wherein the set of virtual input queues further includes a virtual input queue associated with a source address of the packet.

11. A port circuit of a switching device for managing virtual queues, wherein the switching device includes multiple output ports and the port circuit includes multiple input ports, the port circuit comprising:
a memory controller that allocates a virtual output queue for each output port of the switching device and a set of one or more virtual input queues for each virtual output queue, the set of virtual input queues including a virtual input queue associated with an input port of the port circuit;
a virtual output queue selector that selects a virtual output queue associated with an output port to which a packet received by the port circuit is destined;
a virtual input queue selector that identifies a virtual input queue of the selected virtual output queue, the virtual input queue being associated with the input port through which the packet was received by the port circuit; and
a packet access module that accesses the packet in a packet buffer referenced by a pointer in the identified virtual input queue.

12. The port circuit of claim 11 wherein a distinct virtual input queue is allocated for each input port forming a non-blocking flow with an output port corresponding to the virtual output queue.

13. The port circuit of claim 11 wherein a distinct virtual input queue is allocated for each input port forming a non-blocking flow with an output port corresponding to the virtual output queue and a level of service supported by the input port and the output port.

14. The port circuit of claim 11 wherein a virtual input queue is allocated to be shared by each input port that does not form a non-blocking flow with an output port corresponding to the virtual output queue.

15. The port circuit of claim 11 wherein a virtual input queue is allocated to be shared by each input port that does not form a non-blocking flow with an output port corresponding to the virtual output queue and a level of service supported by the input port and the output port.

16. The port circuit of claim 11 wherein the virtual input queue selector determines a pointer to the virtual input queue of the selected virtual output queue to identify the virtual input queue into which the packet should be inserted, wherein the virtual input queue is associated with the input port through which the packet was received by the port circuit.

17. The port circuit of claim 11 wherein the virtual input queue selector arbitrates among the virtual input queues of the selected virtual output queue to select a virtual input queue from which to transmit the packet from the switching device.

18. The port circuit of claim 11 wherein packet buffer access module copies the packet into the packet buffer referenced by the pointer in the identified virtual input queue.

19. The port circuit of claim 11 wherein the packet buffer access module extracts the packet from the packet buffer at the head of the selected virtual input queue and transmits the packet toward the output port of the switching device.

20. The port circuit of claim 11 wherein the set of virtual input queues further includes a virtual input queue associated with a source address of the packet.

21. A method of managing virtual queues in a port circuit of a switching device, wherein the switching device includes multiple output ports and the port circuit includes multiple input ports, the method comprising:
allocating a virtual input queue for each input port of the switching device and a set of one or more virtual output queues for each virtual input queue, the set of virtual output queues including a virtual output queue associated with an output port of the port circuit;
selecting a virtual input queue associated with an input port through which a packet is received by the port circuit;
identifying a virtual output queue of the selected virtual input queue, the virtual output queue being associated with the output port to which the packet is destined; and
accessing the packet in a packet buffer referenced by a pointer in the identified virtual output queue.

22. The method of claim 21 wherein the accessing operation comprises:
extracting the packet from the packet buffer referenced by the pointer in the selected virtual output queue;
transmitting the extracted packet toward the output port of the switching device.

23. A port circuit of a switching device for managing virtual queues, wherein the switching device includes multiple output ports and the port circuit includes multiple input ports, the port circuit comprising:
a memory controller that allocates a virtual input queue for each input port of the switching device and a set of one or more virtual output queues for each virtual input queue, the set of virtual output queues including a virtual output queue associated with an output port of the port circuit;
a virtual input queue selector that selects a virtual input queue associated with an input port through which a packet is received by the port circuit;
a virtual output queue selector that identifies a virtual output queue of the selected virtual input queue, the virtual output queue being associated with the output port to which the packet is destined; and
a packet access module that accesses the packet in a packet buffer referenced by a pointer in the identified virtual output queue.

24. The port circuit of claim 23 wherein packet buffer access module copies the packet into the packet buffer referenced by the pointer in the identified virtual output queue.

25. The port circuit of claim 23 wherein the packet buffer access module extracts the packet from the packet buffer referenced by the pointer in the selected virtual output queue and transmits the packet toward the output port of the switching device.
